(19) United States
(12) Patent Application Publication
(10) Pub. No.: US 2010/0110585 A1
(43) Pub. Date: May 6, 2010

(54) Perpendicular magnetic recording write head with a trailing shield

(75) Inventors: Kenichi Takano, Cupertino, CA (US); Joe Smyth, Aptos, CA (US); Moris Dovek, San Jose, CA (US)

Correspondence Address: SAILE ACKERMAN LLC, 28 DAVIS AVENUE, POUGHKEEPSIE, NY, 12603, US

(73) Assignee: Headway Technologies, Inc.

(21) Appl. No.: 12/290,720

(22) Filed: Nov. 3, 2008

(51) Int. Cl. G11B 5/10

(52) U.S. Cl. 360/123.12; G9B/5.034

(57) ABSTRACT

Insertion of a two part trailing shield between the write gap and the upper return pole of a magnetic write head reduces the sensitivity of the latter to increases in the current driving the field coils (beyond the required minimum). A key feature is careful control of the distance between the upper component of the write shield and the main pole. A process for manufacturing the structure is outlined.

### FIELD OF THE INVENTION

The invention relates to the general field perpendicular magnetic poles for magnetic recording with particular reference accidental writing on adjacent recording tracks.

### BACKGROUND OF THE INVENTION

Perpendicular magnetic recording (PMR) heads combined with double-layered media make it possible to further enhance the increase in recording density in hard disk drives (HDD). Additionally, a trailing shielded pole PMR head can be used to provide a large head field gradient which improves the write transition quality even more.

Sometimes, however, a trailing shield may induce magnetic saturation of the media soft under layer (SUL) between the main-pole and the trailing shield, i.e. in the write-gap region, resulting in severe return field partial erasure (RFPE) of the write pattern. In addition, along the trailing shield edge there is a field of opposite polarity to the main pole which can spread in the cross-track direction. So it can be a cause of wide track erasure. These erasures become more severe in association with large write currents. Therefore, as write current increases in a conventional PMR head, the head field will also increase causing the magnetic write track width to become strongly dependent on the write current. Next track and far track erasures can become severe as well.

A routine search of the prior art was performed with the following references of interest being found:

In U.S. Pat. No. 7,221,539, Takano et al. (Headway) show a stitched shield 40 and main shield 55 similar to the first and second shields of the invention while U.S. Pat. No. 7,009,812 (Hsu et al.) discloses a two-part trailing shield. U.S. Pat. No. 4,656,546 (Mallory) teaches a large shield and a write pole tip with a small gap therebetween and U.S. Pat. No. 4,935,832 (Das et al) describes downstream pole portions that provide side shielding for the write pole.

### SUMMARY OF THE INVENTION

It has been an object of at least one embodiment of the present invention to provide a perpendicular magnetic write head that has low sensitivity to increases in the current driving the field coils beyond the required minimum.

Another object of at least one embodiment of the present invention has been to enhance the field gradient across the write gap.

Still another object of at least one embodiment of the present invention has been to suppress the formation of a fringing field as current to the field coils increases.

A further object of at least one embodiment of the present invention has been to provide a process for the manufacture of said write head.

These objects have been achieved by inserting a two-part trailing shield between the main pole and the upper return pole. By careful control of the distance between the upper trailing shield and the main pole, the head has been rendered insensitive to large increases in the write current beyond the minimum needed for writing.

The trailing shield design disclosed in the present invention minimizes induced magnetic saturation of the media soft under layer in the write-gap region, thereby largely eliminating severe partial erasure of the write pattern as well as wide track erasure. Next track and far track erasures are also largely eliminated by this design.

### BRIEF DESCRIPTION OF THE DRAWINGS

FIGS. 1a and 1b illustrate the full read-write head with curved and planar upper return poles respectively.

FIG. 2 is a close-up view of the upper and lower trailing shields.

FIG. 3 shows the starting point for the process of the present invention

FIG. 4 shows the hard mask that will define the trench for the main pole.

FIGS. 5 and 6 are ABS and side views respectively of the main pole.

FIG. 7 shows formation of the write-gap and the lower trailing shield.

FIGS. 8 and 9 are side and ABS views, respectively, of the upper and lower trailing shields.

FIG. 10 shows the completed write head.

FIGS. 11a and 11b are plots of the y and x components, respectively, of the write field as a function of the write current

FIG. 12 plots the effective width of the write field (in microns) as a function of the write current.

FIG. 13 plots the effective maximum value of the fringe field at a distance of 0.2 microns off the active write track as a function of the write current (write field within the write track is 7,000 Oe).

FIGS. 14 and 15 together illustrate why the claimed range for d is critical.

FIGS. 16 and 17 are plots of the fringe field and the write field, respectively, as a function of distance from the track edge.

### DESCRIPTION OF THE PREFERRED EMBODIMENTS

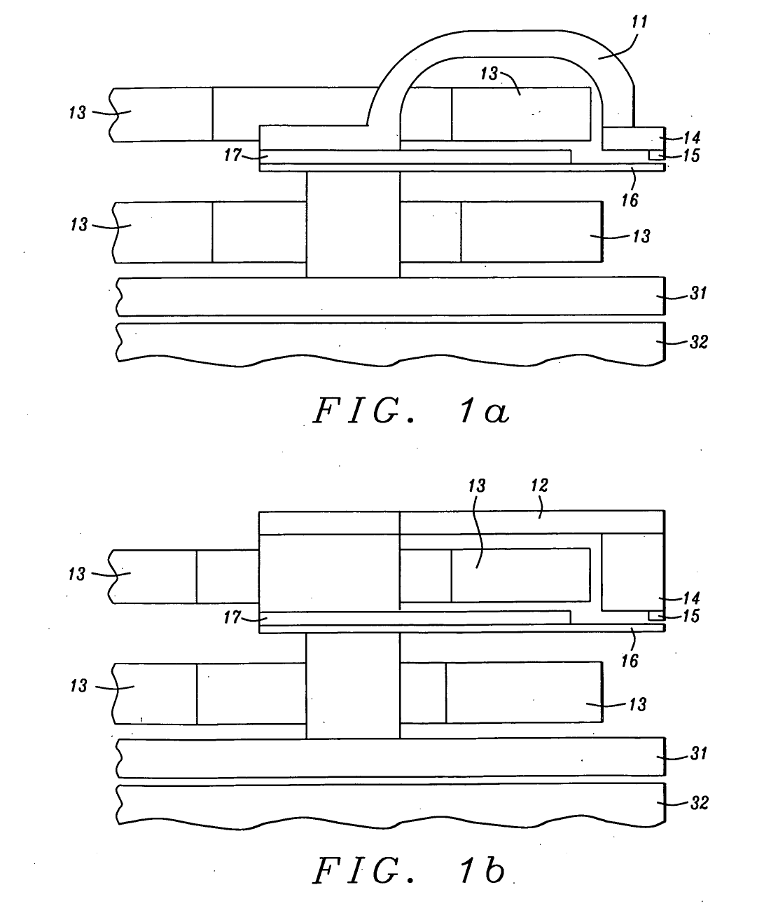

FIGS. 1a and 1b provide an overall view of the full write head of the present invention. Shown in both figures is main pole 16 and lower return pole 17. Immediately above and below poles 16 and 17 are field coils 13 which are immersed in aluminum oxide, the upper coil being sealed in position by the upper return pole. The latter is element 11 in FIG. 1a and element 12 in FIG. 1b.

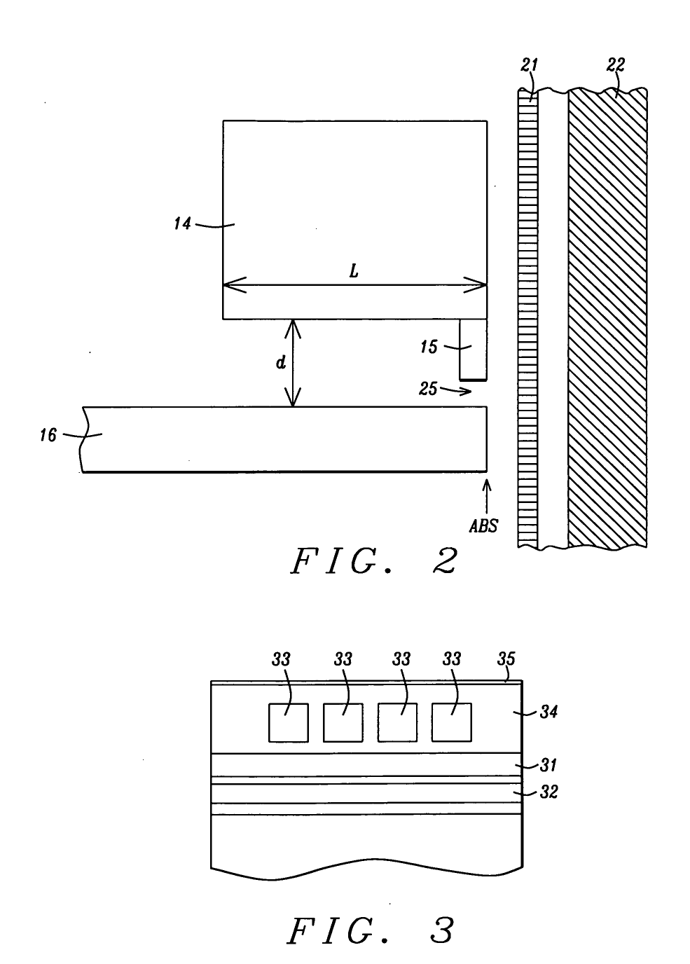

Trailing shields 14 and 15, which are key novel features of the present invention, are in similar locations in both versions of the full write head, with write gap 25 being between lower shield 15 and main pole 16, as can be seen in the enlarged view provided in FIG. 2. For the invention to perform as will be described below, it is critical that distance d (between the lower edge of the upper trailing shield and main pole 16) be precisely controlled to be at least 0.15 microns but no greater than 0.5 microns. It is also important that the width of the upper trailing shield be in a range of from 0.5 to 2.5 microns although a variation of up to about 0.1 microns in either direction is tolerable.

Also shown in FIG. 2 are recording medium 21 and high permeability (magnetically soft) under-layer 22, the latter serving to provide the return path for flux from main pole 16 to upper return pole 11 by way of trailing shields 14 and 15.

We now provide a description of a process for forming the write head of the present invention, particularly the trailing shield structure:

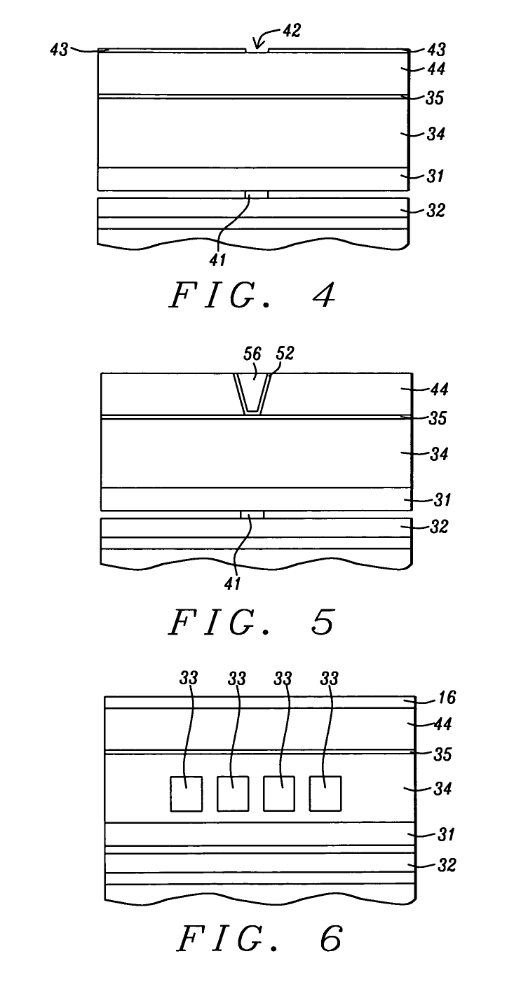

The process begins with the provision of a TMR or GMR read element 41 sandwiched between upper and lower shields 31 and 32, respectively, as shown in FIGS. 3 and 4. FIG. 3 is a side view in which field coil 33 can be seen while FIG. 4 is an ABS view in which read element 41 can be seen. Also seen in both FIGS. 3 and 4 is ruthenium layer 35 which will be used later as an etch stop layer. FIG. 4 represents a later stage in the process than FIG. 3 so it also shows alumina layer 44 which has been deposited onto ruthenium layer 35. Next, a second ruthenium layer was deposited onto the surface of layer 44 where it was patterned to form hard mask 43 that included opening 42.

This was followed by the formation of trench 52 in the area defined by opening 42 and extending through layer 44 as far as etch stop layer 35, as shown in FIG. 5 (which is an ABS view). Then, trench 52 was overfilled with FeCoN and Chemical Mechanical Polishing (CMP) was used to remove all excess magnetic material, as well as the hard mask material, from the surface of layer 44, thereby forming main pole 16 as can be seen in side view in FIG. 6.

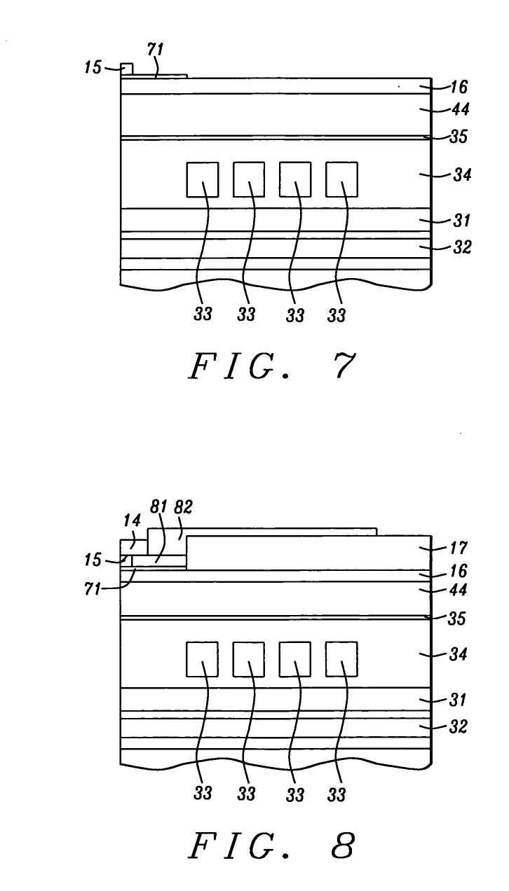

Referring now to FIG. 7, it can be seen that an alumina layer has been patterned to form small ledge 71 that will be used to define the write gap as well as to support lower trailing shield 15. FIG. 8 illustrates a critical process step, namely the formation of insulating ledge 81 which will be used to support upper trailing shield 14. This step is critical in that the combined thickness of layers 71 and 81, which determine the distance between the upper trailing shield and the main pole (distance d in FIG. 2), must be at least 0.15 microns but no more than 0.5 microns.

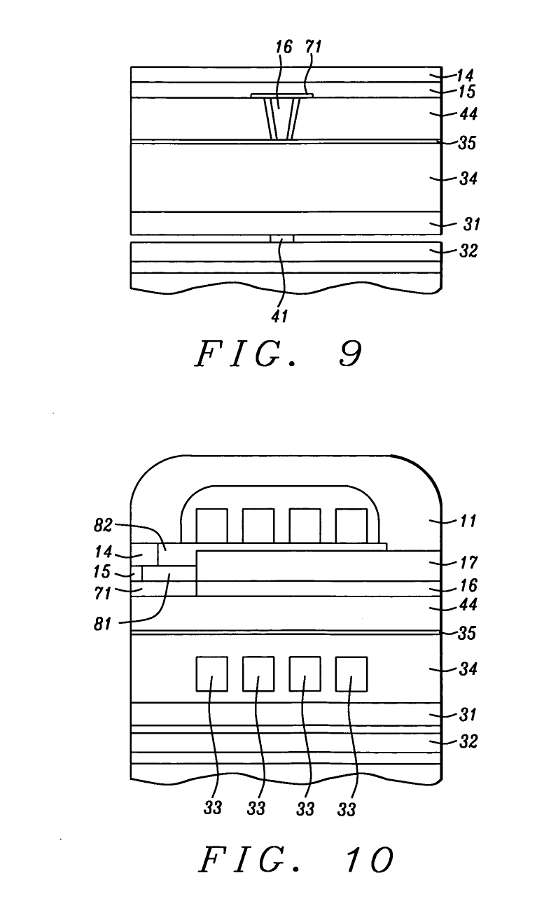

FIG. 9 is an ABS view of FIG. 8

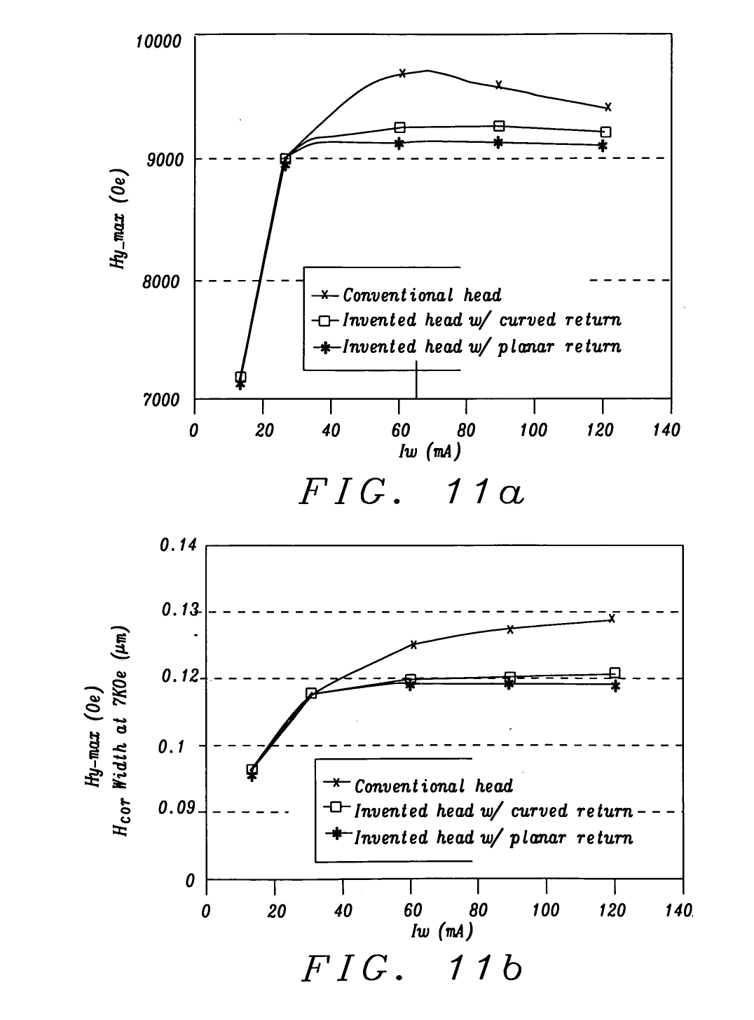

Formation of the write head is completed with the formation of alumina layer 82 which covers lower return pole 17 so as to provide a substrate on which second set of field coils 93 can be formed, as illustrated in FIG. 10.

### Results:

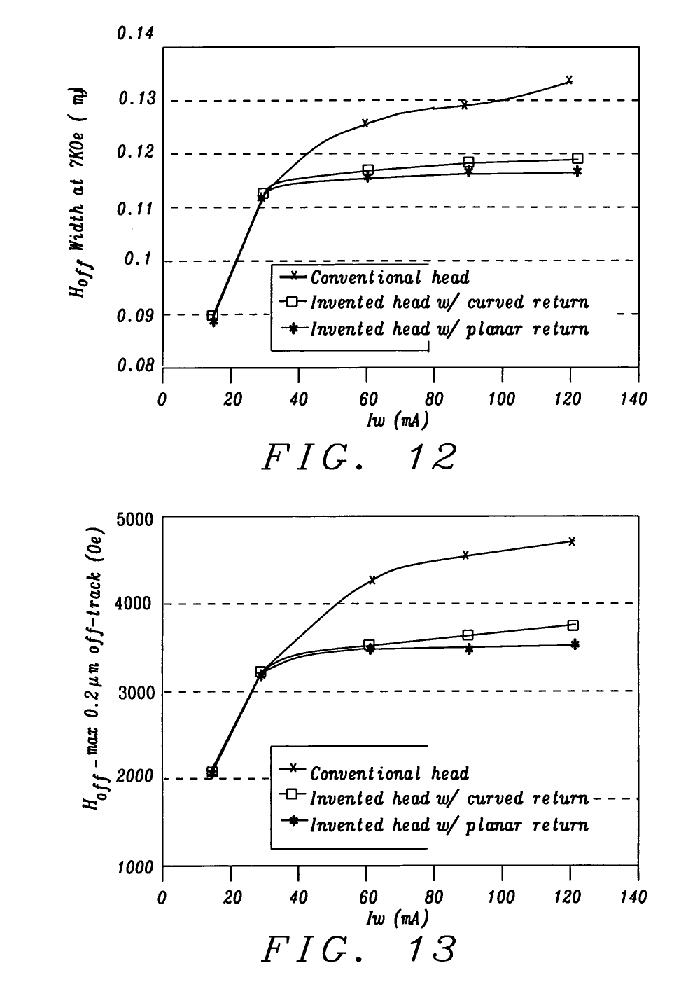

The upper and lower parts of the trailing shield structure of the present invention serve as a larger head field gradient enhancer and as a main-pole flux controller, respectively. As a result, the write field and the field width level off despite further increases in the write current. This is shown in FIGS. 11a and 11b which display the y and x components, respectively, of the write field as a function of the write current for the write head of the invention (both curved and planar return pole versions) as compared to a conventional read head (having no dual trailing shields). As can be seen, the invented head, particularly when a planar upper return pole is also used, shows virtually no field increase even though the write current has more than tripled in value.

Another important feature of the invention is that the fringing field is suppressed (relative to prior art designs) especially at high write currents. FIG. 12 plots the maximum width of the effective head field at 7 kOe (in microns) as a function of the write current. As can be seen, the field width of the invented write head (with planar return pole) does not grow larger than about 0.115 microns even when the write current is increased from about 40 mA to about 120 mA whereas for a write head of the prior art it increases to about 0.133 microns over the same write current range—a 20% increase over the present invention.

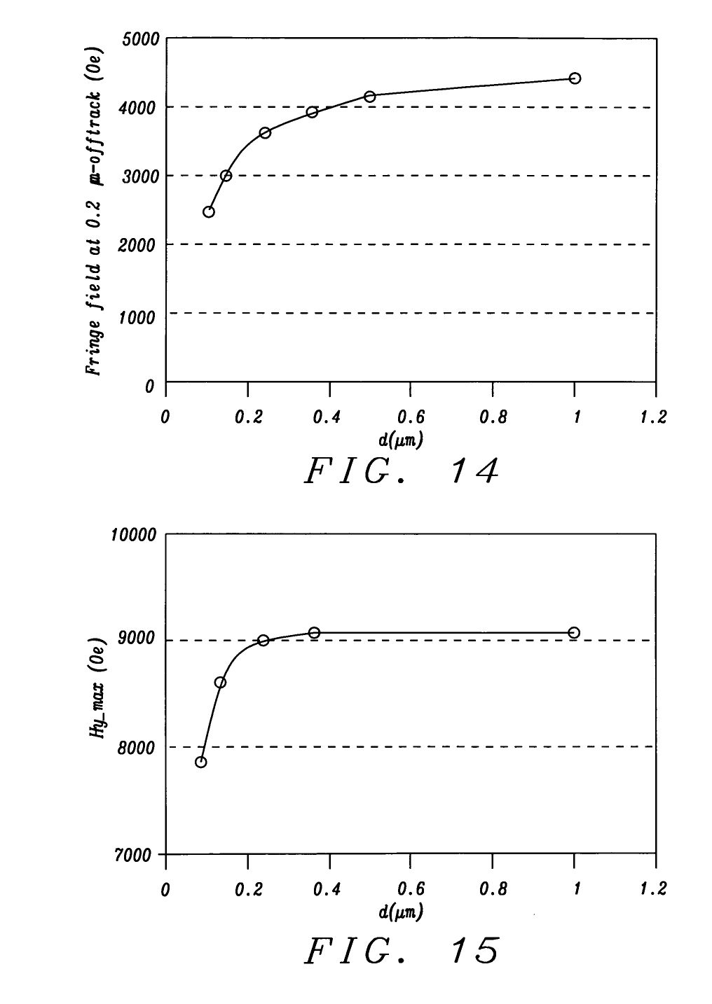

Similarly, FIG. 13 plots the maximum value of the effective head field at a distance of 0.2 microns off the active write track as a function of the write current (write field within the write track is 7,000 Oe). As can be seen, at a write current of 120 mA, the fringe field for the prior art design has increased to about 4,750 Oe whereas for the invented write head it has remained constant at about 3,500 Oe.

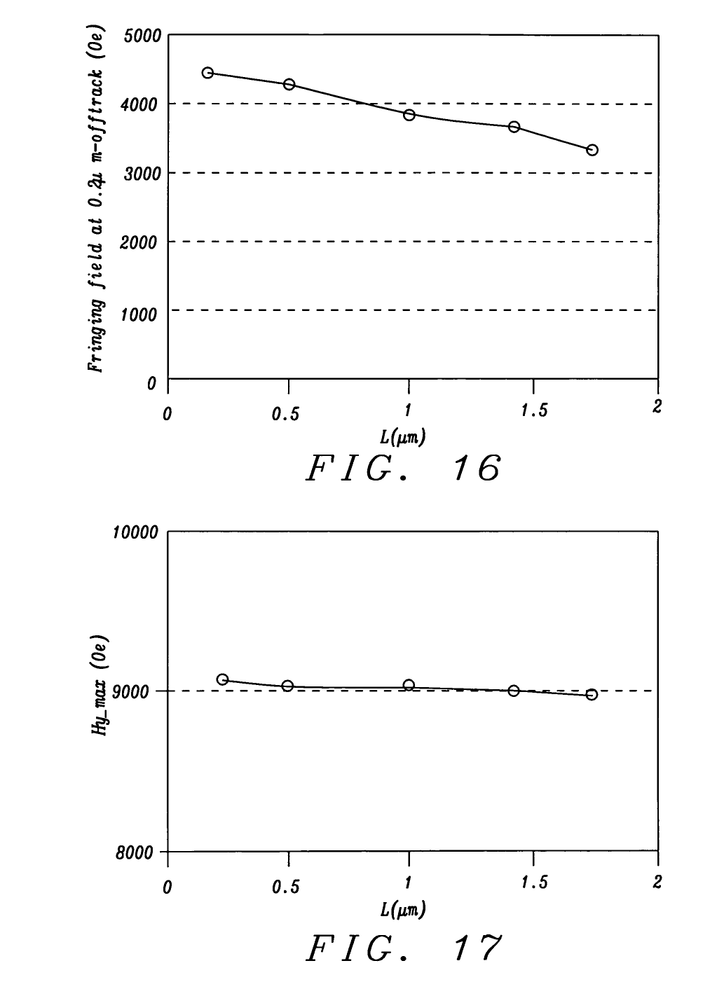

FIGS. 14 and 15 taken together illustrate why the claimed range for d (distance between upper trailing shield and main pole) is critical for optimum operation of the present invention. FIG. 14 shows that there is no advantage for d to exceed 0.5 microns while FIG. 15 shows that the write field falls off very rapidly below 0.15 microns.

FIG. 16 shows that the effective head field at 0.2 microns from the track edge decreases somewhat as L, the width of the upper trailing shield, increases from about 0.2 to about 1.75 microns while FIG. 17 shows that the write field of about 9,000 Oe is essentially independent of L.

Thus, the write head of the present invention offers several advantage over write heads of the prior art including reduced adjacent track erasure, reduced far tracks erasure, reduced return field partial erasure, and improved magnetic track width definition.

What is claimed is:

1. A magnetic write head having a planar air bearing surface (ABS), comprising:
a main pole;
a lower return pole, connected to said main pole;
field coils that serve to energize said main pole;
an upper return pole connected to said lower return pole at a first end and connected to a first trailing shield at a second end;
a second trailing shield that is connected to said first trailing shield, there being a write gap, across which there is a write field having a field gradient, between said second trailing shield and said main pole, said first and second trailing shields and said main pole each having edges that lie in said ABS plane; and
said first trailing shield having a lower edge that is parallel to an upper surface of said main pole whereby said first trailing shield and said main pole are no closer to each other than 0.15 microns and no further apart than 0.5 microns.

2. The magnetic write head described in claim 1 wherein said first trailing shield has a width in a range of from 0.5 to 2.5 microns.

3. The magnetic write head described in claim 1 wherein said second trailing shield extends away from said first trailing shield for a distance that is in a range of from 0.15 to 0.5 microns, whereby said write gap is in a range of from 0.02 to 0.1 microns.

4. The magnetic write head described in claim 1 wherein said first trailing shield serves to enhance said field gradient across the write gap.

5. The magnetic write head described in claim 1 wherein said second trailing shield acts as a main-pole flux controller, whereby said write field levels off as current to said field coils increases.

6. The magnetic write head described in claim 1 wherein said first and second trailing shield together serve to suppress formation of a fringing field as current to said field coils increases.

7. The magnetic write head described in claim 1 wherein said upper return pole is planar whereby a normal write current to said field coils may be increased by a factor of up to 3 without affecting said magnetic write head's write field.

8. The magnetic write head described in claim 1 wherein said upper return pole is planar whereby a normal write current to said field coils may be increased by a factor of up to 3 without affecting said magnetic write head's write field width.

9. The magnetic write head described in claim 1 wherein said upper return pole is planar whereby normal write currents to said field coils may be increased by a factor of up to 3 without affecting fringe fields located 0.2 microns from an active write track.

10. A process for the manufacture of a magnetic write head, having an air bearing surface (ABS), comprising:
providing a magneto-resistive read element sandwiched between upper and lower shields, there being a first insulating layer on said upper shield and a lower field coil being encased within said first insulating layer;
depositing a first ruthenium layer on said first insulating layer;
depositing a second insulating layer on said first ruthenium layer;
depositing a second ruthenium layer on said second insulating layer;
patterning said second ruthenium layer to form a hard mask that includes an opening to define a trench;
forming said trench by etching said second insulating layer at said opening as far as said first ruthenium layer;
then overfilling said trench with FeCoN and then using Chemical Mechanical Polishing (CMP) to remove all excess magnetic material, as well as said first ruthenium layer, thereby forming a main pole for said write head;
then, through successive depositions followed by patterning, forming, on said main pole, a non-magnetic write-gap layer and a lower return pole that is substantially thicker than said write-gap layer and that makes butted contact thereto;
then forming a lower trailing shield on said write-gap layer, said lower trailing shield extending away from the ABS for a short distance whereby a first space is left between said lower trailing shield and said lower return pole;
filling said first space with a support layer of non-magnetic material and then forming an upper trailing shield on said lower trailing shield and on part of said support layer whereby a second space is left between said upper trailing shield and said upper return pole;
depositing and then patterning a third insulating layer to fill said second space and to cover a portion of said upper return pole;
ensuring that said write gap layer and said support layer have a combined thickness that is at least 0.15 microns and no more than 0.5 microns; and
completing manufacture of said write head by forming an upper field coil that is encased within an upper return pole.

11. The process recited in claim 10 wherein said upper trailing shield has a width in a range of from 0.5 to 2.5 microns and a thickness that is in a range of from 0.3 to 2.5 microns.

12. The process recited in claim 10 wherein said lower trailing shield has a width in a range of from 0.05 to 0.25 microns and a thickness that is in a range of from 0.15 to 0.5 microns.

13. The process recited in claim 10 wherein said write gap layer has a thickness that is in a range of from 0.02 to 0.1 microns.

14. The process recited in claim 10 wherein said first. Second, and third insulating layers are selected from the group consisting of alumina, SiO₂, AlN, SiC, or resin.

15. The process recited in claim 10 wherein said lower trailing shield acts as a main pole flux controller.

16. The process recited in claim 10 wherein said upper and lower trailing shields together serve to suppress formation of fringing fields.

17. The process recited in claim 10 wherein said upper return pole is planar.
